(19) United States
(12) Patent Application Publication
(10) Pub. No.: US 2026/0178109 A1
(43) Pub. Date: Jun. 25, 2026

(54) Adaptive Voltage Regulator Configurations

(71) Applicants: Advanced Micro Devices, Inc, Santa Clara, CA (US); ATI Technologies ULC, Markham (CA)

(72) Inventors: Karthik Rao, Cedar Park, TX (US); Ashwini Chandrashekhara Holla, Ajax (CA)

(73) Assignees: Advanced Micro Devices, Inc, Santa Clara, CA (US); ATI Technologies ULC, Markham (CA)

(21) Appl. No.: 18/991,127

(22) Filed: Dec. 20, 2024

(51) Int. Cl. G06F 1/3296; G06F 1/3206

(52) U.S. Cl. CPC G06F 1/3296; G06F 1/3206

(57) ABSTRACT

Dynamically modifying voltage regulator modes based on a computing system workload is described. System management circuitry assesses activity and energy demands of a computing system’s hardware components for a given workload and adapts voltage regulator configuration settings to ensure that the voltage regulator is operating in a mode that is optimized for the workload. In some implementations, modifying voltage regulator configuration settings causes a voltage regulator to transition from a current mode to a different mode. Alternatively or additionally, modifying configuration settings causes the voltage regulator to continue operating in a current mode with a different rate of voltage mitigation.

### BACKGROUND

Computing systems use voltage regulators to ensure that the compute units (e.g., central processing units and accelerated processing units) and other system components receive a stable and consistent supply of voltage. Compute units and other system components are sensitive to fluctuations in power, which can lead to errors, reduced performance, or even damage. Voltage regulators convert varying input voltages from power sources into precise, steady voltage levels, thus maintaining computing system reliability and efficiency while protecting hardware from power-related issues.

### BRIEF DESCRIPTION OF THE DRAWINGS

FIG. 1 is a block diagram of a processing system configured to execute one or more applications, in accordance with one or more implementations.

FIG. 2 is a block diagram of an example system configured to implement voltage regulators with adaptable configuration settings based on characteristics of a computing system workload in accordance with the techniques described herein.

FIG. 3 depicts an example of system management circuitry defining voltage regulator configuration settings that dictate an output voltage by which a voltage regulator powers at least one computing system component.

FIG. 4 depicts a procedure in an example implementation of modifying configuration settings for a voltage regulator based on a computing system workload.

FIG. 5 depicts a procedure in an example implementation of a voltage regulator providing power to a computing system according to configuration settings that are modified based on changes to one or more workloads executed by the computing system.

### DETAILED DESCRIPTION

Voltage regulators in computing systems play a crucial role in managing power efficiency and stability by providing the precise voltage levels required by various components within the computing system. For instance, computing systems often contain multiple subsystems, such as central processing units, graphical processing units, memory devices, peripheral interfaces, and so forth, each of which require different voltage levels for optimal operation. Voltage regulators ensure that system components receive a stable and appropriate voltage, which is essential for maintaining performance, reducing power consumption, and protecting the computing system from voltage fluctuations that could cause malfunction or damage. By integrating voltage regulators within a computing system, finer control over power distribution is achievable, leading to improved energy efficiency and longer battery life in mobile devices, embedded devices, and other computing systems.

Voltage regulators are configurable with different operating modes, such as a fixed voltage output mode, a decay mode, and a clamp down mode. In a fixed voltage output mode, an output voltage provided by the voltage regulator does not change. In a decay mode, an output voltage provided by a voltage regulator is allowed to decrease or “decay” from a current voltage level to a target voltage level that is less than the current voltage level. In implementations, a rate at which the output voltage decays to the target voltage level is non-linear and occurs naturally (e.g., the output voltage decays from a current output voltage to a target output voltage at a rate that is defined by hardware characteristics, such as input capacitance and impedance of a powered circuit). In a clamp down mode, an output voltage provided by a voltage regulator is ramped down by internal circuitry, such as a Pulse Width Modulation (PWM) controller, from a current voltage level (e.g., an output voltage actively being provided by a voltage regulator) to a target voltage level. During clamp down mode, a rate at which the output voltage decreases to the target voltage level is linear, in contrast to the non-linear decrease of the decay mode. In general, decay mode takes longer to transition from a current voltage level to a target voltage, relative to clamp down mode transitioning from the current voltage level to the target voltage.

Conventionally, voltage regulators are assigned a single mode at system startup (e.g., at boot time for the computing system), such that a mode assigned to a voltage regulator is fixed and does not change (e.g., the voltage regulator persists operating a fixed voltage output mode, a decay mode, or a clamp down mode). Each voltage regulator mode has performance benefits and disadvantages. For instance, a fixed output voltage mode prohibits a voltage regulator from reducing computing system power consumption in scenarios when power is unnecessary, such as when a computing system is idle, during local media playback at the computing system, and so forth. A decay mode causes a voltage regulator to naturally discharge from a current output to a target output slowly (e.g., over tens of milliseconds), relative to the rapid discharge (e.g., tens of microseconds) achieved by a clamp down mode. The clamp down mode requires a PWM controller to transition to the target output voltage and transitions the voltage regulator at a programmable rate.

However, the clamp down mode incurs considerable power consumption, as the rapid transition to a target voltage (e.g., zero volts) requires significant power to subsequently recharge input capacitors of the voltage regulator. Conventionally, a voltage regulator decay mode does not involve a PWM controller and thus often requires less power than is otherwise necessary to recharge the input capacitors of a voltage regulator operating in a clamp down mode. For instance, if a target voltage is zero volts, the relatively slow transition of the decay mode results in the voltage regulator subsequently being recharged from a voltage level greater than zero (e.g., due to the system triggering a voltage regulator recharge before its output voltage has fully decayed to zero). Thus, a computing system’s power consumption efficiency is often dependent on its specific configuration of fixed mode voltage regulators, decay mode voltage regulators, and clamp down voltage regulators. However, an optimal voltage regulator configuration for one computational task is often different than the optimal voltage regulator configuration for another computational task performed by the same computing system, thus resulting in excessive power consumption (e.g., when the correct voltage regulator mode is not utilized for a given computational task).

To address these conventional shortcomings, dynamically modifying voltage regulator modes based on a computing system’s workload is described. The described techniques involve assessing activity and energy demands of a computing system’s hardware components for a given workload and adapting voltage regulator configuration settings to ensure that the voltage regulator is operating in a mode that is optimized for the workload. Advantageously, the described techniques are capable of dynamically adapting voltage regulator configuration settings based on a current or upcoming state of the computing system, which is not possible using conventional approaches that statically assign an operating mode to a voltage regulator at system boot time and do not reconfigure the voltage regulator until a subsequent system boot.

To do so, a computing system includes system management circuitry, which is configured to continuously monitor and assess a computing system state based on one or more computational tasks performed as part of executing a workload. In this manner, a computing system state is dependent on a behavior of one or more applications running on (e.g., executed by) the computing system. After detecting a current system workload, an upcoming system workload, or a combination thereof, the system management circuitry applies configuration settings to one or more voltage regulators, where the configuration settings are tailored to optimize system power consumption. As described herein, optimizing system power consumption ensures that each system component (e.g., compute units, memory devices, interfaces, and so forth) is provided with sufficient power to perform its intended functionality without consuming more power than necessary.

In some implementations, a voltage regulator is initialized (e.g., upon system boot) with configuration settings for a first mode (e.g., configuration settings for a decay mode, a clamp down mode, or a fixed voltage output mode). In response to the system management circuitry identifying that a current or scheduled workload is associated with a power consumption threshold that is not satisfied by the initial configuration settings, the system management circuitry is configured to modify the voltage regulator configuration settings to satisfy the power consumption threshold. In some implementations, modifying the voltage regulator configuration settings causes the voltage regulator to transition from a first mode to a second mode (e.g., from a decay mode to a clamp down mode, from a clamp down mode to a decay mode, from a decay mode to a fixed voltage output mode, from a clamp down mode to a fixed voltage output mode, from a fixed voltage output mode to a decay mode, or from a fixed voltage output mode to a clamp down mode). Alternatively, in some implementations modifying the voltage regulator configuration settings causes the voltage regulator to continue operating in a current mode with a different rate of voltage mitigation (e.g., continue operating in a clamp down mode or a decay mode, but with a different rate of transitioning from a current output voltage to a target output voltage).

The system management circuitry is further configured to monitor system performance during execution of a workload defined by one or more computational tasks and adjust the voltage regulator configuration settings as necessary to ensure optimal power consumption for a power consumption threshold associated with the workload. Advantageously, and in contrast to conventional systems, the system management circuitry adjusts voltage regulator configuration settings independent of (e.g., without) interrupting execution of the one or more computational tasks that constitute the computing system workload. In implementations, the power consumption threshold of a workload is inversely proportional to an idle duration of one or more computing system components during execution of the workload (e.g., longer idle durations correlate to reduced power consumption, while shorter idle durations correlate to increased power consumption).

In implementations, the system management circuitry leverages known techniques to identify a power consumption threshold associated with a workload. For instance, the system management circuitry leverages a network of sensors associated with different computing system components, such as central processing units, graphical processing units, memory devices, data communication devices, and so forth, which provide real-time data describing factors such as voltage consumed by, current generated by, and temperature of individual computing system components. Based on such example sensor data, the system management circuitry evaluates how much power is required for the system to function effectively, adapting dynamically to the demands of the workload. Alternatively or additionally, parameters that are useable to identify a power consumption threshold associated with a workload include idle durations, such as a central processing unit idle duration, a graphical processing unit idle duration, other system component idle durations, combinations thereof, and so forth. As described herein, a “workload” encompasses a broad range of one or more computational tasks, such as operations executed by system software, firmware, hardware, or combinations thereof.

Generally, power consumption thresholds can be categorized into three categories: an idle power consumption threshold, a moderate power consumption threshold, and a high power consumption threshold. As a specific example, the system management circuitry identifies that a workload is associated with an idle power consumption threshold when no significant computational tasks are being performed (e.g., when one or more system hardware components are underutilized). An idle power consumption threshold scenario, for instance, is characterized by low activity levels among central processing units, graphical processing units, and so forth. The idle power consumption threshold causes the system management circuitry to place the computing system into a low-power scenario by configuring voltage regulator settings to provide reduced power to the computing system (e.g., to reduce compute unit clock speed, power down or throttle non-essential circuits, and so forth). The idle power consumption threshold may be further associated with power-saving features such as turning off a computing system display device, putting storage devices into sleep mode, and so forth. Thus, the idle power consumption threshold is generally representative of reduced computing system energy demands, such that system power consumption is minimal.

As another specific example, the system management circuitry identifies that a workload is associated with a moderate power consumption threshold in scenarios such as during local media playback (e.g., watching a movie stored locally on the computing system), where the system balances between efficient power usage and maintaining sufficient resources to smoothly handle the media playback. For workloads associated with a moderate power consumption threshold, the system management circuitry, for instance, configures voltage regulator settings to provide power for increasing compute unit clock speeds to handle media playback processing, but only to an extent necessary for smooth playback. Relative to an idle power consumption threshold, system voltage requirements for a workload associated with a moderate power consumption threshold are increased due to more system components being actively engaged. Despite this increased power demand, the system management circuitry continues to optimize energy consumption by avoiding unnecessary overhead.

Continuing these specific examples, the system management circuitry identifies that a workload is associated with a high power consumption threshold in scenarios such as when a computing system is streaming media (e.g., playing back media stored at a remote computing device connected to the computing system via a network), engaging in web browsing, and so forth. Executing workloads associated with high power consumption thresholds cause computing system components to be more active (e.g., relative to idle and moderate power consumption threshold workloads), such as due to streaming media content in high resolution or rendering graphics-heavy web elements. For high power consumption threshold workloads, the system management circuitry configures voltage regulator settings for frequent adjustment of power allocations to different system components to ensure that the system can handle workload intensity changes without performance degradation.

In each of these example scenarios, the system management circuitry configures voltage regulator settings to dynamically allocate power. By tracking factors such as component temperature, a history of system component idle durations, a prediction of system component idle durations, and so forth, the system management circuitry is further configured to anticipate heat generated by higher power consumption workloads and preemptively increase system fan speeds or limit clock rates to prevent overheating. Additionally, through historical power profiles and workload analysis, the system management circuitry is configured to predict energy demands for different computational tasks, adjusting voltage regulator configuration settings in a manner that balances performance with energy efficiency.

These three examples of power consumption thresholds are described herein for contextual purposes and are not limiting, as one of ordinary skill in the art will readily appreciate that any number of power consumption thresholds can be defined for a computing system, where each power consumption threshold is associated with a different set of voltage regulator configuration settings. This precise power management afforded by the techniques described herein advantageously extends portable device battery life ensures overall longevity and stability of the computing systems in a manner that is not afforded by conventional voltage regulator configurations.

In some aspects, the techniques described herein relate to a device including a voltage regulator configured to provide power to a computing system in an operating mode while the computing system is executing one or more tasks, transition from the operating mode to a different operating mode while the computing system is executing the one or more tasks, and continue providing power to the computing system in the different operating mode while the computing system is executing the one or more tasks.

In some aspects, the techniques described herein relate to a device, wherein the operating mode includes a decay mode and the different operating mode includes a clamp down mode.

In some aspects, the techniques described herein relate to a device, wherein the operating mode includes a decay mode and the different operating mode includes a fixed voltage output mode.

In some aspects, the techniques described herein relate to a device, wherein the operating mode includes a clamp down mode and the different operating mode includes a decay mode.

In some aspects, the techniques described herein relate to a device, wherein the operating mode includes a clamp down mode and the different operating mode includes a fixed voltage output mode.

In some aspects, the techniques described herein relate to a device, wherein the operating mode includes a fixed voltage output mode and the different operating mode includes a decay mode.

In some aspects, the techniques described herein relate to a device, wherein the operating mode includes a fixed voltage output mode and the different operating mode includes a clamp down mode.

In some aspects, the techniques described herein relate to a device, wherein the operating mode includes a decay mode with a first decay rate and the different operating mode includes the decay mode with a second decay rate, wherein the first decay rate is different than the second decay rate.

In some aspects, the techniques described herein relate to a device, wherein the operating mode includes a clamp down mode with a first clamp down rate and the different operating mode includes the clamp down mode with a second clamp down rate, wherein the first clamp down rate is different than the second clamp down rate.

In some aspects, the techniques described herein relate to a device, wherein the voltage regulator is configured to transition from the operating mode to the different operating mode independent of interrupting the computing system executing the one or more tasks.

In some aspects, the techniques described herein relate to a device, wherein the voltage regulator is configured to transition from the operating mode to the different operating mode in based on configuration settings received from the computing system.

In some aspects, the techniques described herein relate to a device, wherein the configuration settings correspond to a power consumption threshold for the computing system executing the one or more tasks.

In some aspects, the techniques described herein relate to a device, wherein the voltage regulator includes power modulation circuitry that is configured to provide power to the computing system by transitioning a current output voltage to a target output voltage at a rate defined by the configuration settings.

In some aspects, the techniques described herein relate to a system including a computing device including at least one compute unit configured to execute one or more computational tasks, and system management circuitry configured to generate configuration settings that define how one or more voltage regulators provide power to the computing device, and the one or more voltage regulators, at least one of the one or more voltage regulators configured to transition, based on the configuration settings, from providing power to the computing device in a first operating mode to providing power to the computing device in a second operating mode while the at least one compute unit is executing the one or more computational tasks.

In some aspects, the techniques described herein relate to a system, wherein the first operating mode includes a decay mode and the second operating mode includes a clamp down mode.

In some aspects, the techniques described herein relate to a system, wherein the first operating mode includes a decay mode that transitions to a target output voltage at a first decay rate and the second operating mode includes the decay mode that transitions to the target output voltage at a second decay rate, wherein the first decay rate is different than the second decay rate.

In some aspects, the techniques described herein relate to a system, wherein the first operating mode includes a clamp down mode and the second operating mode includes a decay mode.

In some aspects, the techniques described herein relate to a system, wherein the first operating mode includes a clamp down mode that transitions to a target output voltage at a first clamp down rate and the second operating mode includes the clamp down mode that transitions to the target output voltage at a second clamp down rate, wherein the first clamp down rate is different than the second clamp down rate.

In some aspects, the techniques described herein relate to a method including communicating, by system management circuitry of a computing device, configuration settings that instruct a voltage regulator to power the computing device in a first mode, receiving, by the computing device, voltage from the voltage regulator under the first mode while the computing device is executing one or more computational tasks, communicating, by the system management circuitry, different configuration settings that instruct the voltage regulator to power the computing device in a second mode, and receiving, by the computing device, voltage from the voltage regulator under the second mode while the computing device is executing the one or more computational tasks.

In some aspects, the techniques described herein relate to a method, wherein the first mode is different than the second mode, and wherein the different configuration settings are defined based on a power consumption threshold associated with the one or more computational tasks.

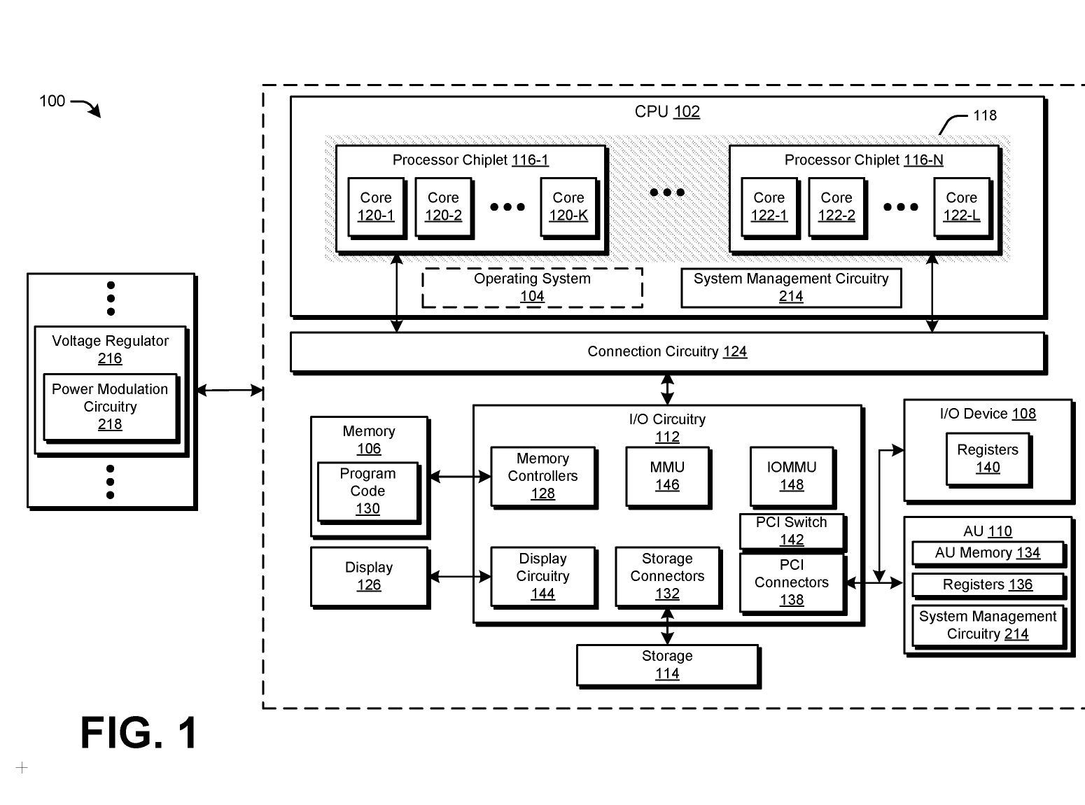

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

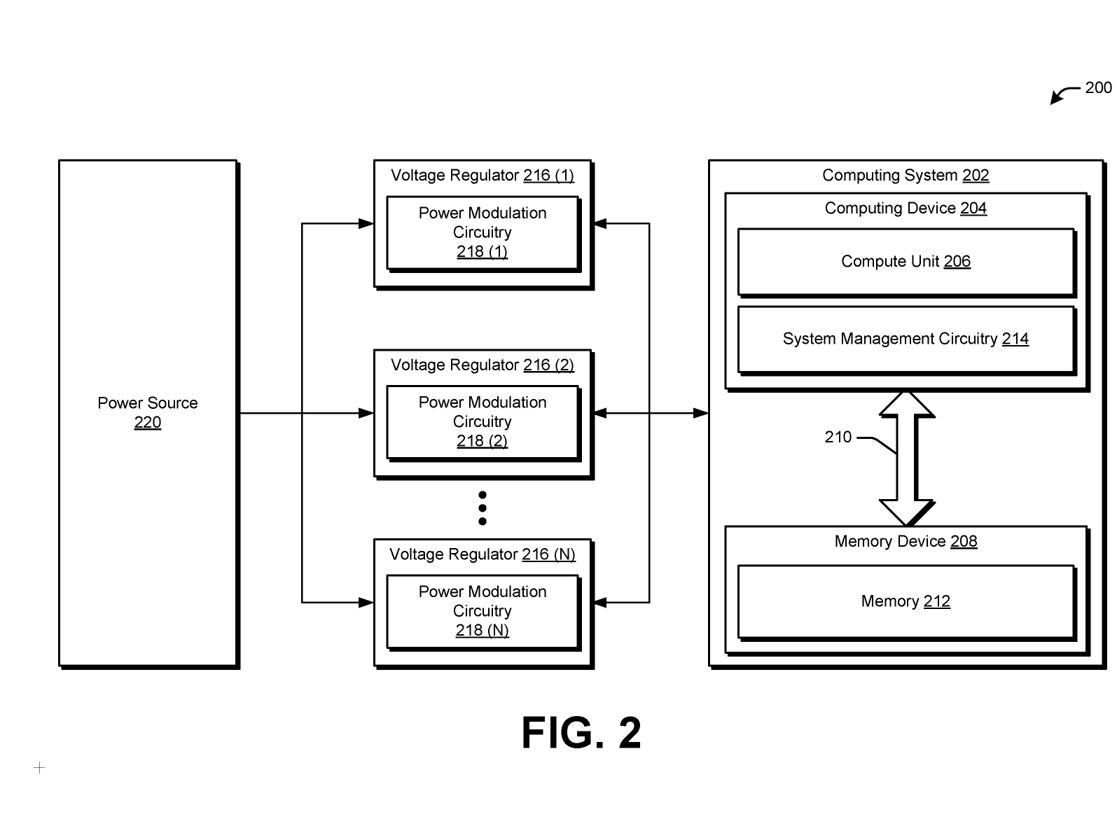

The processing system 100 is configured to receive power from at least one voltage regulator 216, where a specific output voltage provided by the voltage regulator 216 is controlled based on configuration settings defined by the system management circuitry 214 (e.g., configuration settings that control operation of the power modulation circuitry 218), as described in further detail below with respect to FIG. 2. In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof. In some implementations, the CPU 102 includes system management circuitry 214, such that the CPU 102 represents an instance of the computing device 204, as described in further detail below with respect to FIG. 2. Alternatively or additionally, the AU 110 includes the system management circuitry 214, such that the AU 110 represents an instance of the computing device 204.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example implementation depicted in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both. In this manner, the compute unit 206 of FIG. 2 is representative of at least one processor core 120, 122, at least one processor chiplet 116, or combinations thereof.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. These memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. The memory controllers 128 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106.

Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

FIG. 2 is a block diagram of an example system 200 configured to implement voltage regulators with adaptable configuration settings based on characteristics of a computing system workload in accordance with the techniques described herein. In the illustrated example of FIG. 2, the system 200 includes a computing system 202, which is generally represented as including a computing device 204 with at least one compute unit 206. The computing device 204 is coupled to a memory device 208 via an interface 210. The system 200, the computing system 202, the computing device 204, the compute unit 206, the memory device 208, and the interface 210 are each representative of a range of different hardware configurations, as described in further detail with respect to FIG. 1.

In one or more implementations, the memory device 208 is a circuit board (e.g., a printed circuit board) on which memory 212 (e.g., physical memory such as dynamic random-access memory) is mounted. Alternatively, in some implementations, the memory device 208 is an integrated circuit or physical chip in which memory 212 is incorporated. The computing device 204 is configured to manage the flow of data to and from the memory 212. By way of example, the computing device 204 includes circuitry to read from, and write to, the memory 212. The computing device 204 further includes system management circuitry 214, which represents functionality of the computing device 204 to identify a workload for the computing system 202.

As described herein, a “workload” refers to one or more tasks or operations that the computing system 202 processes or executes, which are measurable in terms of computational effort, time, and resource usage required to perform the one or more tasks or operations. A workload of the computing system 202 thus encompasses various activities such as a number of instructions executed by the compute unit 206, parallel processing of data by an accelerated instance of the compute unit 206, accesses to data stored in the memory 212 of the memory device 208, and so forth. As a specific example, a central processing unit workload includes executing arithmetic operations, managing control flow, and performing input/output operations. As another specific example, a graphical processing unit workload involves rendering graphics by executing thousands of threads simultaneously across different compute units. As yet another specific example, a memory device workload involves loading data from the memory 212 into a cache of the computing device 204. Thus, as described herein, a workload refers to a totality of system resources required to execute computational tasks.

The system management circuitry 214 represents functionality of the computing system 202 to define configuration settings for at least one voltage regulator that provides power to the computing system 202, such as voltage regulator 216. In the illustrated example of FIG. 2, the computing system 202 is depicted as receiving power via voltage regulator 216(1), voltage regulator 216(2), and voltage regulator 216(N). The illustrated example of FIG. 2, however, is not limiting, as the described techniques are applicable to a system that receives power from any number of voltage regulators, such that N is representative of any integer. Each voltage regulator 216 includes power modulation circuitry 218. Power modulation circuitry 218 represents internal circuitry of a voltage regulator 216 that functions to transition output voltage provided by the voltage regulator 216 from a current level to a target level at a defined rate. For instance, in one or more implementations the power modulation circuitry 218 is configured as a PWM controller.

In implementations, the rate at which the power modulation circuitry 218 transitions output voltage from a current level to a target level is controlled by configuration settings defined by the system management circuitry 214. When a voltage regulator 216 is in a mode other than a clamp down mode (e.g., a decay mode or a fixed output voltage mode), the power modulation circuitry 218 is inactive, and the voltage regulator 216 transitions from a current level to a target level defined by configuration settings assigned by the system management circuitry 214 without invoking the power modulation circuitry 218. For instance, in some implementations a voltage regulator 216 operating in decay mode includes multiple different input capacitor, such that an appropriate input capacitor is selected based on the decay rate as defined by the configuration settings assigned by the system management circuitry 214.

Each voltage regulator 216 is thus configured to provide the computing system 202 with a controlled output voltage from the power source 220 as defined by configurations settings received from the system management circuitry 214. The power source 220 is representative of an electrical energy source, such as a battery, a power supply unit, or the like. The power source 220 thus delivers electrical energy to the voltage regulator 216, which modulates a voltage of the electrical energy based on configuration settings assigned by the system management circuitry 214.

For a given computing system 202 workload, the system management circuitry 214 is configured to identify a power consumption threshold associated with the workload. The power consumption threshold is generally representative of energy demands of one or more hardware components of the computing system 202. In implementations, the power consumption threshold of a workload is inversely proportional to an idle duration of one or more components of the computing system 202 during execution of the workload (e.g., longer idle durations correlate to reduced power consumption, while shorter idle durations correlate to increased power consumption).

As an example, when the computing system 202 initializes (e.g., boots, power cycles, or otherwise begins operation from a powered-off state), the system management circuitry 214 assigns initial configuration settings to a voltage regulator 216. The initial configuration settings, for example, cause the voltage regulator 216 to operate in a decay mode with a first decay rate. The decay mode causes the voltage regulator 216 to transition from a current output voltage to a target output voltage, where the first decay rate specifies a non-linear voltage decrease over a defined amount of time. In some implementations, the first decay rate is associated with a high power consumption threshold, such that computing system 202 is initially prepared to handle computationally intensive workloads, such as web browsing, streaming media playback, and so forth.

After initialization, in response to detecting a change in workload for the computing system 202, the system management circuitry 214 is configured to modify configuration settings for the voltage regulator 216. For instance, the system management circuitry 214 detects that a current or upcoming workload of the computing system 202 is associated with a moderate power consumption threshold, such as a workload involving playback of media locally stored at the computing system 202 (e.g., media stored in the memory 212). For a moderate power consumption threshold, the system management circuitry 214 issues configuration settings that cause the voltage regulator 216 to operate in a decay mode with a second decay rate. The second decay rate causes the voltage regulator 216 to transition from a current output voltage to a target output voltage in a non-linear manner over a defined amount of time that is different than the defined amount of time for the first decay rate. For example, the second decay rate causes the voltage regulator 216 to transition from the current output voltage to the target output voltage more rapidly than the first decay rate.

The system management circuitry 214 is configured to continuously monitor, and adapt to, changes in computing system 202 workloads. For instance, continuing the above example where the system management circuitry 214 initializes a voltage regulator 216 with configuration settings for a high power consumption threshold, then modifies the configuration settings for the voltage regulator to adapt to a moderate power consumption threshold, consider a scenario where the system management circuitry 214 identifies a subsequent workload associated with an idle power consumption threshold. In this scenario, the system management circuitry 214 issues configuration settings that cause the voltage regulator 216 to operate in a clamp down mode with a first clamp down rate.

The first clamp down rate causes the power modulation circuitry 218 of the voltage regulator 216 to transition the current output voltage provided by the voltage regulator 216 to a target output voltage in a linear manner over a defined duration. Alternatively or additionally, the system management circuitry 214 defines configuration settings that cause the voltage regulator 216 to operate in a clamp down mode with a second clamp down rate, where the second clamp down rate causes transition from the current output voltage to the target output voltage over a duration of time that is different than the first clamp down rate.

In accordance with the techniques described herein, different voltage regulators 216 may be assigned with different configuration settings, either upon initialization, in response to a specific workload of the computing system 202, or combinations thereof. Thus, although described herein with respect to issuing and modifying configuration settings for a single voltage regulator 216, the system management circuitry 214 is configured to cause different voltage regulators 216 to operate in different modes, in same modes with different decay or clamp down rates, combinations thereof, and so forth. In implementations, different configuration settings are associated with different target output voltages, different rates of transition from current to target output voltages, combinations thereof, and so forth. Thus, the specific examples provided herein are not limiting with respect to the described systems and techniques.

In this manner, the system 200 ensures that one or more voltage regulators 216 power the computing system 202 in an optimized manner, based on one or more workloads of the computing system 202.

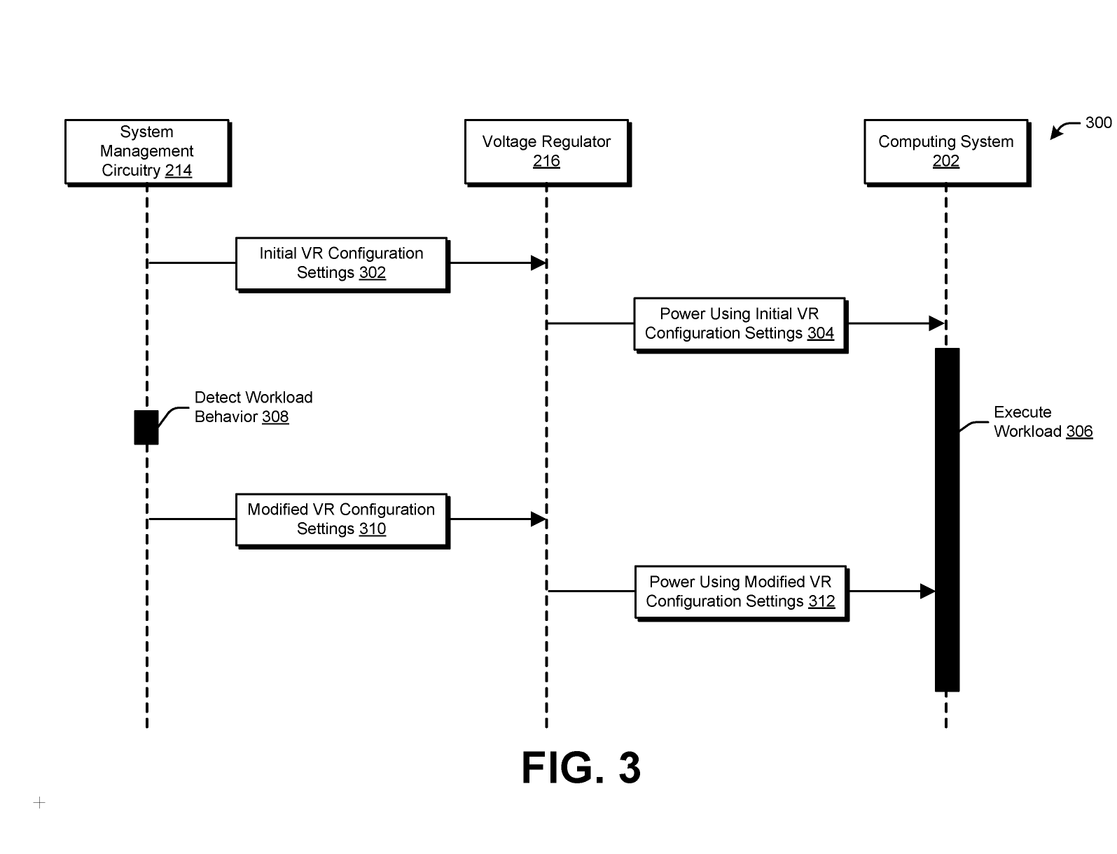

FIG. 3 depicts an example 300 of system management circuitry defining voltage regulator configuration settings that dictate an output voltage by which a voltage regulator powers at least one computing system component. The example 300 is depicted as including the computing system 202, the system management circuitry 214, and the voltage regulator 216 of FIG. 2. Upon startup of the computing system 202 (e.g., from a powered-off state), the system management circuitry 214 assigns initial voltage regulator configuration settings 302 to the voltage regulator 216. The voltage regulator 216 is then configured to power the computing system using the initial voltage regulator configuration settings 304. Upon being powered using the initial voltage regulator configuration settings 304, the computing system 202 is equipped to begin executing workload 306 (e.g., the computing system 202 begins performing one or more computational tasks that collectively define the workload 306).

The system management circuitry 214 is configured to detect workload behavior 308. In implementations, the system management circuitry 214 leverages known techniques to identify a power consumption threshold associated with the workload 306. For instance, the system management circuitry 214 leverages a network of sensors included in the computing system 202 that are individually associated with different components of the computing system 202, such as central processing units, graphic processing units, memory devices, storage devices, and other components as described in further detail with respect to FIG. 1. Such sensors and other workload behavior detection systems and techniques provide real-time data describing factors such as voltage consumed by, current generated by, and temperature of individual computing system components.

Using such sensor data, as one example, detecting workload behavior 308 is generally representative of the system management circuitry 214 evaluating how much power is required for the computing system 202 system to function effectively and efficiently. In some implementations, the system management circuitry 214 detects workload behavior 308 for the workload 306 before the computing system 202 initiates execution of the workload 306. Alternatively or additionally, the system management circuitry 214 detects workload behavior 308 during execution of the workload 306 (e.g., after the computing system 202 has begun executing the workload 306 and prior to completion of the workload 306).

In response to detecting that the workload behavior 308 is associated with a power consumption threshold other than a power consumption threshold associated with the initial voltage regulator configuration settings 302, the system management circuitry 214 generates modified voltage regulator configuration settings 310. The modified voltage regulator configuration settings 310 are representative of configuration settings that cause the voltage regulator 216 to provide at least minimum power requirements for the computing system 202 to execute the workload 306. Upon receiving the modified voltage regulator configuration settings 310, the voltage regulator 216 is configured to power the computing system 202 using the modified voltage regulator configuration settings 312. In implementations, the modified voltage regulator configuration settings 310 cause the voltage regulator 216 to operate in a different mode than the initial voltage regulator configuration settings 302. Alternatively, the modified voltage regulator configuration settings 310 cause the voltage regulator 216 to operate in a same mode as the initial voltage regulator configuration settings 302, but with different rates of voltage mitigation (e.g., different decay rates or different clamp down rates).

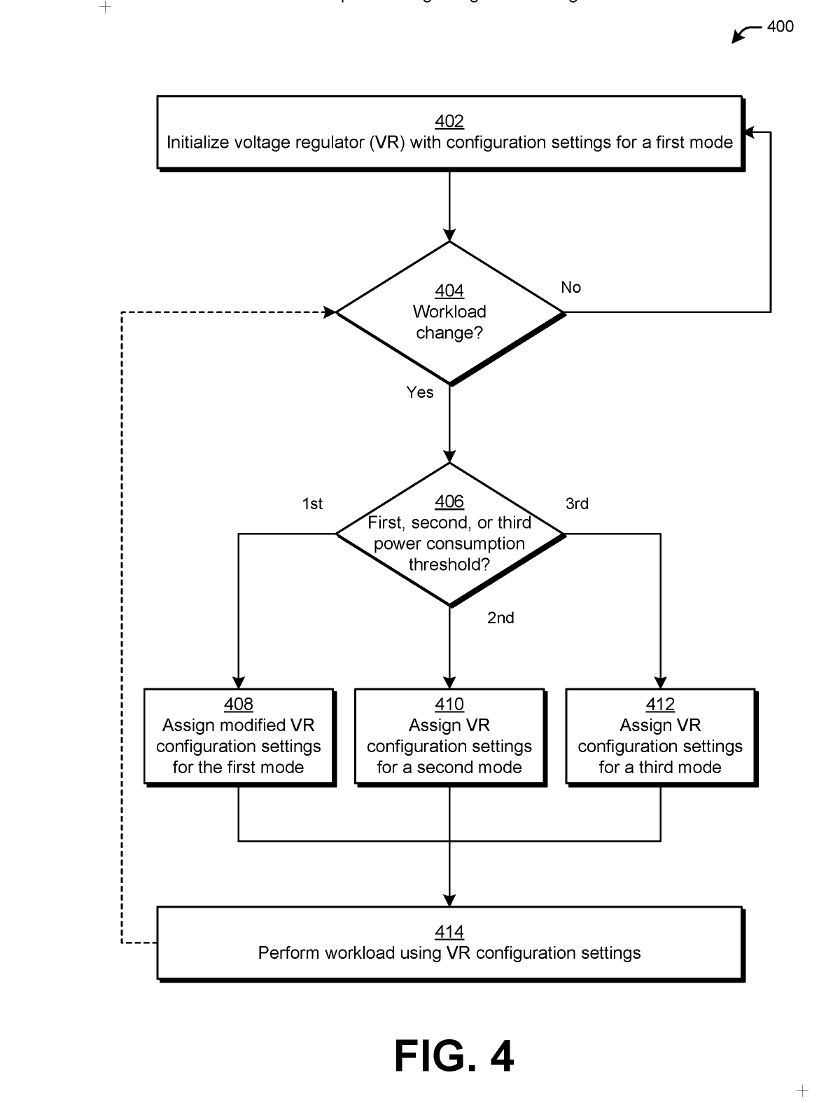

FIG. 4 depicts a procedure 400 in an example implementation of modifying configuration settings for a voltage regulator based on a computing system workload. To begin, a voltage regulator is initialized with configuration settings for a first mode (block 402). The system management circuitry 214, for instance, provides initial voltage regulator configuration settings 302 to the voltage regulator 216 and causes the voltage regulator 216 to power the computing system 202 using the initial voltage regulator configuration settings 304. In some implementations, the initial voltage regulator configuration settings 302 cause the voltage regulator 216 to operate in a decay mode. Alternatively, the initial voltage regulator configuration settings 302 cause the voltage regulator 216 to operate in a clamp down mode. Alternatively, the initial voltage regulator configuration settings 302 cause the voltage regulator 216 to operate in a fixed voltage output mode.

The system management circuitry 214 then monitors the computing system 202 to determine whether a change in workload occurs at the computing system 202 (block 404). In the absence of a workload change at the computing system 202 (e.g., a “No” determination at block 404), operation returns to block 402 and the voltage regulator 216 continues to operate using the configuration settings for the first mode. Alternatively, in response to a workload change at the computing system 202 (e.g., a “Yes” determination at block 404), a determination is made as to whether the new workload is associated with a first, second, or third power consumption threshold (block 406).

The system management circuitry 214, for instance, ascertains power consumption requirements for a computing system 202 workload using known techniques and identifies a corresponding power consumption threshold that satisfies the power consumption requirements without wasting energy. In response to identifying that the new workload is associated with a first power consumption threshold, modified voltage regulator configuration settings for the first mode are assigned to the voltage regulator (block 406). As a specific example, in an instance where the first mode is a decay mode, the modified voltage regulator configuration settings 310 cause the voltage regulator 216 to continue operating in the decay mode with a different decay rate. Alternatively, in an instance where the first mode is a clamp down mode, the modified voltage regulator configuration settings cause the voltage regulator 216 to continue operating in the clamp down mode with a different clamp down rate.

Alternatively, in response to identifying that the new workload is associated with a second power consumption threshold, voltage regulator configuration settings for a second mode are assigned to the voltage regulator (block 410). The system management circuitry 214, for instance, generates modified voltage regulator configuration settings 310 that cause the voltage regulator 216 to transition from operating in the first mode to operating in a second mode. For instance, continuing the example scenario where the first mode is a decay mode, the modified voltage regulator configuration settings 310 cause the voltage regulator 216 to transition from operating in the decay mode to operating in a clamp down mode.

Alternatively, in response to identifying that the new workload is associated with a third power consumption threshold, voltage regulator configuration settings for a third mode are assigned to the voltage regulator (block 412). The system management circuitry 214, for instance, generates modified voltage regulator configuration settings 310 that cause the voltage regulator 216 to transition from operating in the first mode to operating in a third mode. For instance, continuing the example scenario where the first mode is a decay mode and the second mode is a clamp down mode, the modified voltage regulator configuration settings 310 cause the voltage regulator 216 to transition from operating in the decay mode to operating in a fixed output voltage mode.

Given the modified voltage regulator configuration settings 310 assigned via block 408, block 410, or block 412 (e.g., the modified voltage regulator configuration settings 310) the voltage regulator 216 powers the computing system 202 using the modified voltage regulator configuration settings 312. The computing system 202 then continues to execute a workload as powered by the voltage regulator 216 according to the modified voltage regulator configuration settings 312 (block 414). Operation of procedure 400 optionally continues for one or more additional workloads, or changes to a current workload, as indicated by the dashed arrow returning to block 404 from block 414. In such an implementation where operation of procedure 400 returns to block 404 from block 414, a subsequent “No” determination at block 404 causes the voltage regulator 216 to continue operating using currently assigned configuration settings (e.g., the modified voltage regulator configuration settings 310 assigned via block 408, block 410, or block 412).

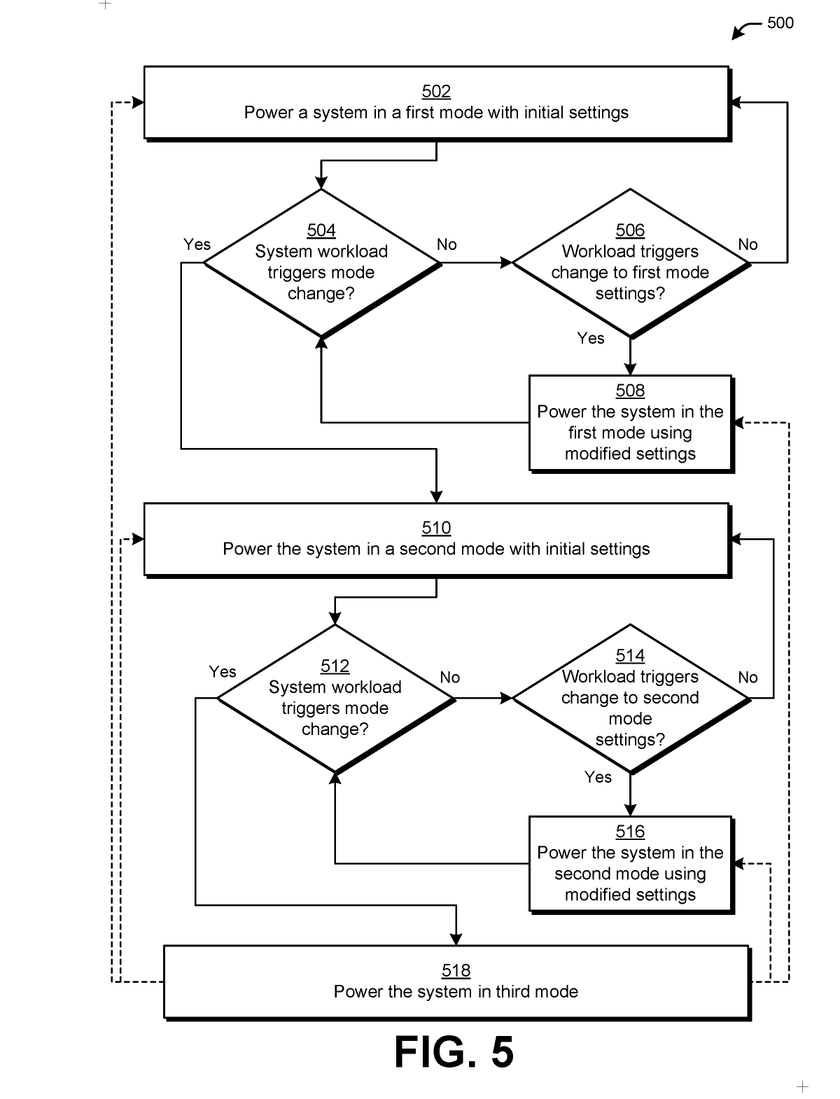

FIG. 5 depicts a procedure 500 in an example implementation of a voltage regulator providing power to a computing system according to configuration settings that are modified based on changes to one or more workloads executed by the computing system.

To begin, a voltage regulator operates in a first mode with initial settings to power a system (block 502). The voltage regulator 216, for instance, powers computing system 202 in a decay mode according to initial voltage regulator configuration settings 302 for the decay mode. A determination is then made as to whether a system workload triggers a mode change for the voltage regulator (block 504). The system management circuitry 214, for instance, monitors a workload currently executed by the computing system 202, a workload scheduled for execution by the computing system 202, or combinations thereof, to determine whether the workload is associated with a power consumption threshold that necessitates transitioning the voltage regulator 216 from a first mode to a second mode.

In response to determining that the system workload does not trigger a voltage regulator mode change (e.g., a “No” determination at block 504), a determination is then made as to whether the workload triggers a change to the configuration settings for the first mode (block 506). The system management circuitry 214, for instance, monitors a workload currently executed by the computing system 202, a workload scheduled for execution by the computing system 202, or combinations thereof, to determine whether the workload is associated with a power consumption threshold that requires different configuration settings for the first mode (e.g., a different decay rate for a decay mode).

In response to determining that the system workload does not trigger a change to the configuration settings for the first mode (e.g., a “No” determination at block 506), operation of procedure 500 returns to block 502 and the voltage regulator 216 continues to power the computing system 202 according to configuration settings that define the initial settings for the first mode. Alternatively, in response to determining that the system workload triggers a change to the configuration settings for the first mode (e.g., a “Yes” determination at block 506), the voltage regulator powers the system in the first mode using modified settings (block 508). The voltage regulator 216, for instance, powers the computing system 202 according to the modified voltage regulator configuration settings 310, where the modified voltage regulator configuration settings 310 represent different configuration settings for the first mode (e.g., a different decay rate for the decay mode). Operation then returns from block 508 to block 504 and the system continues to monitor whether a workload triggers a mode change.

In response to determining that the system workload triggers a mode change away from the voltage regulator operating in the first mode (e.g., a “Yes” determination at block 504), the voltage regulator operates in a second mode with initial settings to power the system (block 510). The voltage regulator 216, for instance, powers computing system 202 in a clamp down mode according to initial clamp down settings defined by the modified voltage regulator configuration settings 310. A determination is then made as to whether a system workload triggers a mode change for the voltage regulator (block 512). The system management circuitry 214, for instance, monitors a workload currently executed by the computing system 202, a workload scheduled for execution by the computing system 202, or combinations thereof, to determine whether the workload is associated with a power consumption threshold that necessitates transitioning the voltage regulator 216 from the second mode to a third mode.

In response to determining that the system workload does not trigger a voltage regulator mode change (e.g., a “No” determination at block 512), a determination is then made as to whether the workload triggers a change to the configuration settings for the second mode (block 514). The system management circuitry 214, for instance, monitors a workload currently executed by the computing system 202, a workload scheduled for execution by the computing system 202, or combinations thereof, to determine whether the workload is associated with a power consumption threshold that requires different configuration settings for the second mode (e.g., a different clamp down rate for the clamp down mode).

In response to determining that the system workload does not trigger a change to the configuration settings for the second mode (e.g., a “No” determination at block 514), operation of procedure 500 returns to block 510 and the voltage regulator 216 continues to power the computing system 202 according to configuration settings that define the initial settings for the second mode. Alternatively, in response to determining that the system workload triggers a change to the configuration settings for the first mode (e.g., a “Yes” determination at block 514), the voltage regulator powers the system in the second mode using modified settings (block 516). The voltage regulator 216, for instance, powers the computing system 202 according to the modified voltage regulator configuration settings 310, where the modified voltage regulator configuration settings 310 represent different configuration settings for the second mode (e.g., a different clamp down rate for the clamp down mode). Operation then returns from block 516 to block 512 and the system continues to monitor whether a workload triggers a mode change.

In response to determining that the system workload triggers a mode change away from the voltage regulator operating in the second mode (e.g., a “Yes” determination at block 512), the voltage regulator operates in a third mode to power the system (block 510). The voltage regulator 216, for instance, powers computing system 202 in a fixed voltage output mode as defined by modified voltage regulator configuration settings 310.

In some implementations, operation of procedure 500 returns from block 518 to block 502, block 508, block 510, or block 516, as indicated by the respective dashed arrows emanating from block 518 to block 502, block 508, block 510, and block 516. In this manner, the system management circuitry 214 is configured to cause the voltage regulator 216 to adapt to different power consumption requirements of one or more computing system 202 workloads and ensure that the computing system 202 optimizes power consumption during dynamic workload requirements.

Although the procedure 500 is described above with respect to the first, second, and third modes being decay, clamp down, and fixed voltage output modes, respectively, references to first, second, and third modes in the illustrated example of FIG. 5. For instance, in an alternative implementation the first mode is a decay mode, the second mode is a fixed voltage output mode, and the third mode is a clamp down mode. Alternatively, the first mode is a clamp down mode, the second mode is a decay mode, and the third mode is a fixed voltage output mode. Alternatively, the first mode is a clamp down mode, the second mode is a fixed voltage output mode, and the third mode is a decay mode. Alternatively, the first mode is a fixed voltage output mode, the second mode is a decay mode, and the third mode is a clamp down mode. Alternatively, the first mode is a fixed voltage output mode, the second mode is a clamp down mode, and the third mode is a decay mode.

The example techniques described herein are merely illustrative and many variations are possible based on this disclosure. Although features and elements are described above in particular combinations, each feature or element is usable alone without the other features and elements or in various combinations with or without other features and elements. In one or more implementations, the methods and procedures provided herein are implemented in a computer program, software, or firmware incorporated in a non-transitory computer-readable storage medium for execution by a general-purpose computer or a processor, such as a processing system described with respect to FIG. 1.

What is claimed is:

1. A device comprising:
a voltage regulator configured to:
provide power to a computing system in an operating mode while the computing system is executing one or more tasks;
transition from the operating mode to a different operating mode while the computing system is executing the one or more tasks; and
continue providing power to the computing system in the different operating mode while the computing system is executing the one or more tasks.

2. The device of claim 1, wherein the operating mode comprises a decay mode and the different operating mode comprises a clamp down mode.

3. The device of claim 1, wherein the operating mode comprises a decay mode and the different operating mode comprises a fixed voltage output mode.

4. The device of claim 1, wherein the operating mode comprises a clamp down mode and the different operating mode comprises a decay mode.

5. The device of claim 1, wherein the operating mode comprises a clamp down mode and the different operating mode comprises a fixed voltage output mode.

6. The device of claim 1, wherein the operating mode comprises a fixed voltage output mode and the different operating mode comprises a decay mode.

7. The device of claim 1, wherein the operating mode comprises a fixed voltage output mode and the different operating mode comprises a clamp down mode.

8. The device of claim 1, wherein the operating mode comprises a decay mode with a first decay rate and the different operating mode comprises the decay mode with a second decay rate, wherein the first decay rate is different than the second decay rate.

9. The device of claim 1, wherein the operating mode comprises a clamp down mode with a first clamp down rate and the different operating mode comprises the clamp down mode with a second clamp down rate, wherein the first clamp down rate is different than the second clamp down rate.

10. The device of claim 1, wherein the voltage regulator is configured to transition from the operating mode to the different operating mode independent of interrupting the computing system executing the one or more tasks.

11. The device of claim 1, wherein the voltage regulator is configured to transition from the operating mode to the different operating mode in based on configuration settings received from the computing system.

12. The device of claim 11, wherein the configuration settings correspond to a power consumption threshold for the computing system executing the one or more tasks.

13. The device of claim 11, wherein the voltage regulator includes power modulation circuitry that is configured to provide power to the computing system by transitioning a current output voltage to a target output voltage at a rate defined by the configuration settings.

14. A system comprising:
a computing device comprising:
at least one compute unit configured to execute one or more computational tasks; and
system management circuitry configured to generate configuration settings that define how one or more voltage regulators provide power to the computing device; and
the one or more voltage regulators, at least one of the one or more voltage regulators configured to transition, based on the configuration settings, from providing power to the computing device in a first operating mode to providing power to the computing device in a second operating mode while the at least one compute unit is executing the one or more computational tasks.

15. The system of claim 14, wherein the first operating mode comprises a decay mode and the second operating mode comprises a clamp down mode.

16. The system of claim 14, wherein the first operating mode comprises a decay mode that transitions to a target output voltage at a first decay rate and the second operating mode comprises the decay mode that transitions to the target output voltage at a second decay rate, wherein the first decay rate is different than the second decay rate.

17. The system of claim 14, wherein the first operating mode comprises a clamp down mode and the second operating mode comprises a decay mode.

18. The system of claim 14, wherein the first operating mode comprises a clamp down mode that transitions to a target output voltage at a first clamp down rate and the second operating mode comprises the clamp down mode that transitions to the target output voltage at a second clamp down rate, wherein the first clamp down rate is different than the second clamp down rate.

19. A method comprising:
communicating, by system management circuitry of a computing device, configuration settings that instruct a voltage regulator to power the computing device in a first mode;
receiving, by the computing device, voltage from the voltage regulator under the first mode while the computing device is executing one or more computational tasks;
communicating, by the system management circuitry, different configuration settings that instruct the voltage regulator to power the computing device in a second mode; and
receiving, by the computing device, voltage from the voltage regulator under the second mode while the computing device is executing the one or more computational tasks.

20. The method of claim 19, wherein the first mode is different than the second mode, and wherein the different configuration settings are defined based on a power consumption threshold associated with the one or more computational tasks.
